(19) United States
(12) Patent Application Publication
(10) Pub. No.: US 2025/0184302 A1
(43) Pub. Date: Jun. 5, 2025

(54) METHOD AND SYSTEM FOR INDEXING CONTENTS IN INSTANT MESSAGING SERVICE

(71) Applicant: Line Plus Corporation, Seongnam-si (KR)

(72) Inventor: Hyo Jung KIM, Seongnam-si (KR)

(73) Assignee: Line Plus Corporation, Seongnam-si (KR)

(21) Appl. No.: 19/049,435

(22) Filed: Feb. 10, 2025

Related U.S. Application Data
(63) Continuation of application No. PCT/KR2023/007678, filed on Jun. 5, 2023.

(30) Foreign Application Priority Data
Aug. 17, 2022 (KR) 10-2022-0102710

(51) Int. Cl. H04L 51/216; H04L 51/04; H04L 51/10

(52) U.S. Cl. CPC H04L 51/216; H04L 51/04; H04L 51/10

(57) ABSTRACT

A method for indexing content in an instant messaging service, performed by one or more processors of a user terminal, includes: receiving, from a user, a first user input corresponding to a request for content indexing, and a content; receiving a second user input to cause an indexing of the received content; and based on receiving the second user input, generating a folder corresponding to the first user input or the second user input, and storing the received content in the folder.

### CROSS-REFERENCE TO RELATED APPLICATIONS

The present application is a continuation of International Patent Application No. PCT/KR2023/007678, filed on Jun. 5, 2023, which is based upon and claims the benefit of priority to Korean Patent Application No. 10-2022-0102710, filed on Aug. 17, 2022. The disclosures of the above-listed applications are hereby incorporated by reference herein in their entireties.

### BACKGROUND

### 1. Field

The present disclosure relates to a method and a system for indexing content in an instant messaging service, and specifically, to a method and a system for indexing and storing uploaded contents in a chat room of an instant messaging application.

### 2. Description of Related Art

With the proliferation of mobile devices such as smartphones and the development of the Internet, the use of instant messaging applications using mobile devices is becoming widespread. Users who use instant messaging applications through mobile devices may exchange various messages and content with other users through chat rooms.

In the instant messaging application, content uploaded by a particular user to share with other users in a multi-user chat room, or content uploaded as a memo in a personal chat room where only the user participates, may be stored in the application or on an external server for future reference. However, after the content is uploaded and stored through the instant messaging application, various other content may be uploaded as time passes, which may make it difficult for users to navigate back to the content they want.

In addition, in the instant messaging application, a function of classifying content by type and storing it separately may be provided. However, in this case, there is a problem of computing resources being used redundantly for the task of classifying each piece of content and associate it with folders.

### SUMMARY

In order to solve one or more problems (e.g., the problems described above and/or other problems not explicitly described herein), provided is a method and a device (system) for indexing content in an instant messaging service.

The present disclosure may be implemented in a variety of ways, including a method, a device (system) or a computer program stored in a readable storage medium.

According to an aspect of an embodiment, provided is a method for indexing content in an instant messaging service performed by one or more processors of a user terminal, the method may include: receiving, from a user, a first user input corresponding to a request for content indexing, and a content; receiving a second user input to cause an indexing of the received content; and based on receiving the second user input, generating a folder corresponding to the first user input or the second user input, and storing the received content in the folder.

The first user input may be received through a chat room of the instant messaging service.

The content may include at least one of a text, a link, an image, or a video.

The second user input may correspond to a sticker included in the instant messaging service.

The sticker may include a text or an image corresponding to the indexing of the content.

The receiving the second input may include receiving, from the user, an input of the text or the image of the sticker.

The folder corresponding to the first user input or the second user input may be generated based on a type of the sticker.

The method may further include: receiving a third user input to cause a second indexing of the received content; and based on receiving the third user input, generating a sub-folder corresponding to the third user input and within the folder corresponding to the first user input or the second user input, and storing the received content in the sub-folder.

The method may further include displaying, on the received content, a badge corresponding to the sticker.

The method may further include, based on the user selecting the badge corresponding to the sticker, outputting a folder corresponding to the badge on a display of the user terminal.

Based on the content being an image or a video, the folder corresponding to the first user input or the second user input may be generated as a sub-folder of an album.

The receiving the second user input may include receiving, on the content, a designation of a folder to be generated for storing the content.

The method may further include, based on the received content, providing a recommendation of a folder to store the content.

The method may further include, based on the received content, providing a recommendation including at least one sticker corresponding to a folder to store the content.

The at least one sticker included in the recommendation may be a sticker purchased by the user.

The content may be received from a second user, different from the user.

The first user input, the content, and the second user input may be received through a chat room of the instant messaging service, wherein the folder corresponding to the first user input or the second user input corresponds with the chat room.

The first user input, the content, and the second user input may be received through a chat room of the instant messaging service, where the folder corresponding to the first user input or the second user input corresponds with the instant messaging service.

According to an aspect of an embodiment, a non-transitory computer-readable recording medium may store instructions to cause performance of the method including: receiving, from a user, a first user input corresponding to a request for content indexing, and a content; receiving a second user input to cause an indexing of the received content; and based on receiving the second user input, generating a folder corresponding to the first user input or the second user input, and storing the received content in the folder.

According to an aspect of an embodiment, a user terminal may include: a communication module; a memory storing one or more computer-readable programs; a display; and one or more processors operatively connected to the memory and configured to execute the one or more computer-readable programs included in the memory to: receive, from a user, a first user input corresponding to a request for content indexing, and a content, receive a second user input to cause an indexing of the received content, and based on receiving the second input, generate a folder corresponding to the first user input or the second user input, and store the received content in the folder.

According to an aspect of an embodiment, a method for indexing content in an instant messaging service, being performed by one or more processors of a user terminal, may include: receiving, from a user, a first input in a chat room of the instant messaging service corresponding to a request for content indexing; after receiving the first input, receiving content in the chat room of the instant messaging service; after receiving the content, receiving a second user input to cause an indexing of the received content; and based on receiving the second user input, generating a folder corresponding to the first user input or the second user input, and storing the received content in the folder.

According to yet another aspect of the present disclosure, a method for indexing content in an instant messaging service may include receiving, from a user, a third user input associated with content indexing and content, and generating, in response to receiving the content, a folder corresponding to the third user input or the content to store the received content.

The generating, in response to receiving the content, the folder corresponding to the third user input or the content to store the received content may include generating a folder corresponding to the third user input to store a predetermined number of pieces of content from among the received content.

The generating, in response to receiving the content, the folder corresponding to the third user input or the content to store the received content may include generating a folder corresponding to the third user input to store the content received within a predetermined time after the third user input from among the received content.

According to yet another aspect of the present disclosure, a method for indexing content in an instant messaging service may include receiving content from the user, receiving a fourth user input associated with indexing the received content, and generating, in response to receiving the fourth user input, a folder corresponding to the fourth user input or the content to store the received content.

The generating, in response to receiving the fourth user input, the folder corresponding to the fourth user input or the content to store the received content may include generating a folder corresponding to the fourth user input to store a predetermined number of pieces of content from among the received content.

The generating, in response to receiving the fourth user input, the folder corresponding to the fourth user input or the content to store the received content may include generating a folder corresponding to the fourth user input to store content associated with the fourth user input from among the received content.

### BRIEF DESCRIPTION OF DRAWINGS

The above and other objects, features and advantages of certain embodiments of the present disclosure will be more apparent from the following description taken in conjunction with the accompanying drawings, in which:

FIG. 1 illustrates an example of indexing content in an instant messaging service according to an embodiment;

FIG. 2 is a schematic diagram illustrating a configuration in which an information processing system is communicatively connected to a plurality of user terminals to index content in the instant messaging service according to an embodiment;

FIG. 3 is a block diagram of an internal configuration of the user terminal and the information processing system according to an embodiment;

FIG. 4 is a block diagram illustrating an internal configuration of a processor according to an embodiment;

FIG. 5 is a diagram illustrating an example of indexing content according to an embodiment;

FIG. 6 is a diagram illustrating an example of displaying, on content, a badge associated with a sticker after content indexing according to an embodiment;

FIG. 7 is a diagram illustrating an example of recommending a sticker for content indexing according to an embodiment;

FIG. 8 is a diagram illustrating an example in which a user customizes a sticker for content indexing according to an embodiment; and

FIG. 9 is a flowchart provided to explain an example of a method for indexing content in the instant messaging service according to an embodiment.

### DETAILED DESCRIPTION

Hereinafter, one or more example embodiments of the present disclosure will be described in detail with reference to the accompanying drawings. However, in the following description, detailed descriptions of well-known functions or configurations may be omitted.

In the accompanying drawings, the same or corresponding components are given the same reference numerals. In addition, in the following description of various examples, duplicate descriptions of the same or corresponding components may be omitted. However, even if descriptions of components are omitted, it is not intended that such components are not included in any example.

Advantages and features of the disclosed examples and methods of accomplishing the same will be apparent by referring to examples described below in connection with the accompanying drawings. However, the present disclosure is not limited to the examples disclosed below, and may be implemented in various forms different from each other, and the examples are merely provided to make the present disclosure complete, and to fully disclose the scope of the disclosure to those skilled in the art to which the present disclosure pertains.

The terms used herein will be briefly described prior to describing the disclosed example(s) in detail. The terms used herein have been selected as general terms which are widely used at present in consideration of the functions of the present disclosure, and this may be altered according to the intent of an operator skilled in the art, related practice, or introduction of new technology. In addition, in specific cases, certain terms may be arbitrarily selected by the applicant, and the meaning of the terms will be described in detail in a corresponding description of the example(s). Therefore, the terms used in the present disclosure should be defined based on the meaning of the terms and the overall content of the present disclosure rather than a simple name of each of the terms.

The singular forms “a,” “an,” and “the” as used herein are intended to include the plural forms as well, unless the context clearly indicates the singular forms. Further, the plural forms are intended to include the singular forms as well, unless the context clearly indicates the plural forms. Further, throughout the description, the terms “includes,” “comprises,” “has,” “having,” “including,” “comprising,” and variations thereof specify the presence of stated features, figures, steps, operations, components, members, or combinations thereof, but do not preclude the presence or addition of one or more other features, figures, steps, operations, components, members, or combinations thereof.

As used herein, each of the expressions “A or B,” “at least one of A and B,” “at least one of A or B,” “A, B, or C,” “at least one of A, B, and C,” and “at least one of A, B, or C,” may include any one or all possible combinations of the items listed together with a corresponding expression among the expressions.

Further, the term “module” or “unit” as used herein refers to a software or hardware component, and the “module” or the “unit” performs certain roles. However, the meaning of the “module” or “unit” is not limited to software or hardware. The “module” or “unit” may be configured to be in an addressable storage medium or configured to execute one or more processors. Accordingly, as an example, the “module” or “unit” may include components such as software components, object-oriented software components, class components, and task components, and at least one of processes, functions, attributes, procedures, subroutines, program code segments, drivers, firmware, micro-codes, circuits, data, database, data structures, tables, arrays, or variables. Functions provided in the components and the “modules” or “units” may be combined into a smaller number of components and “modules” or “units”, or further divided into additional components and “modules” or “units.”

The “module” or “unit” may be implemented as any number of a processor and a memory. The “processor” should be interpreted broadly to include at least one of a general-purpose processor, a central processing unit (CPU), a microprocessor, a digital signal processor (DSP), a controller, a microcontroller, a state machine, etc. Under some circumstances, the “processor” may include an application-specific integrated circuit (ASIC), a programmable logic device (PLD), a field-programmable gate array (FPGA), etc. The “processor” may include a combination of processing devices, e.g., a combination of a DSP and a microprocessor, a combination of a plurality of microprocessors, a combination of one or more microprocessors in conjunction with a DSP core, or any other combination of such configurations. In addition, the “memory” should be interpreted broadly to include any electronic component that is capable of storing electronic information. The “memory” may include any one or more of various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. The memory is said to be in electronic communication with a processor if the processor can read information from and/or to the memory. The memory integrated with the processor is in electronic communication with the processor.

In one or more embodiments of the present disclosure, a “system” may refer to at least one of a server apparatus and a cloud apparatus, but is not limited thereto. For example, the system may include one or more server apparatus. In some embodiments, the system may include one or more cloud apparatus. In some embodiments, the system may include the server apparatus and the cloud apparatus operated in conjunction with each other.

In one or more embodiments of the present disclosure, a “display” may refer to any display device associated with a computing device, and for example, may refer to any display device that is controlled by the computing device, or that can display any information/data provided from the computing device.

In one or more embodiments of the present disclosure, “each of a plurality of A's” may refer to each of all components included in the plurality of A's, or may refer to each of some of the components included in the plurality of A's.

In one or more embodiments of the present disclosure, an “instant messaging application” may refer to any software or application platform that supports real-time or near real-time communication between users. For example, the “instant messaging application” may include IMessage, WhatsApp, Snapchat, Telegram, or the like, but is not limited thereto. In one or more embodiments of the present disclosure, the service provided by the “instant messaging application” may be referred to as an “instant messaging service.”

In one or more embodiments of the present disclosure, a “user” may refer to a user of the instant messaging application or a user account of the instant messaging application. The user account may refer to an account generated and used by the user in the instant messaging application or data associated therewith.

In one or more embodiments of the present disclosure, a “chat room” may refer to a virtual space or group in which one or more users (or user accounts) may participate, which may be implemented by an instant messaging application installed on the computing device. For example, one or more user accounts may participate or be included in the chat room and exchange various types of messages, files, etc. In addition, the chat room may support Voice over Internet Protocol (VoIP) call or VoIP group call functions, allowing voice calls and/or video calls to be performed between user accounts.

In one or more embodiments of the present disclosure, the “personal chat room” may refer to a virtual space or group in which only the user himself may participate, which may be generated in the instant messaging application installed on the computing device. For example, in the personal chat room, the user may upload various types of texts, images, videos, files, etc. The uploaded texts, images, videos, files, etc. may be accessible only to the user.

In one or more embodiments of the present disclosure, the “content” may include various information or content thereof, which may be produced digitally in forms recognizable by human senses, such as images, texts, videos, voices, etc. and provided to the user. For example, the content may include videos, music, images, voices, web pages, webtoons, texts, SNS posts, etc., but is not limited thereto.

In one or more embodiments of the present disclosure, a “sticker” may refer to a predefined emoticon sticker or indicator provided by the instant messaging service. The sticker may be input to the chat room of the instant messaging application in the same way as a message or through a separate menu. In addition, the sticker may include an image, video, or a text, and the image or the text included in the sticker may be edited by the user. Additionally, the sticker provided by the instant messaging service may be offered for a fee.

In one or more embodiments of the present disclosure, the term “indexing” may refer to a process of identifying, recording, storing, cataloguing, or otherwise organizing specified content from the instant messaging application. The specified content may be indexed into a generated or pre-generated folder.

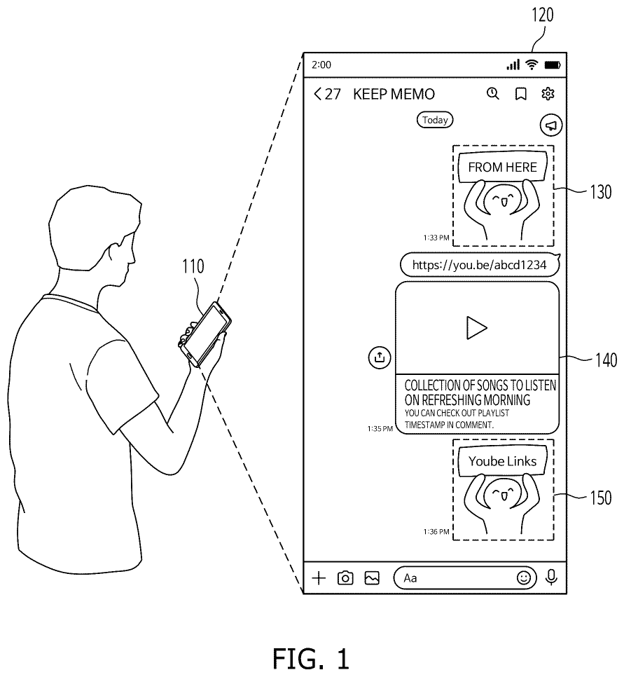

FIG. 1 illustrates an example of indexing the content in the instant messaging service according to an embodiment. The user may use the instant messaging service through the instant messaging application in a user terminal 110. In addition, the user may upload content to various types of chat rooms generated in the instant messaging application or share the content with other users.

The user may upload content 140 from a chat room interface 120 of the instant messaging application displayed on the display of the user terminal 110. For example, the user may upload the content to a personal chat room (or “Keep Memo” chat room), folder, etc. that is accessible only to the user, allowing the user to check the content 140 again later. According to an embodiment, the user may upload the content 140 to the chat room to share the content 140 with other users. The content may include at least one of text, a link, an image, or a video, but is not limited thereto.

If the user uploads various types of content a plurality of times, there is a need to index the content according to its content or type so that the user may navigate to the content desired by the user among the content stored or shared in a non-aligned manner in the chat room or the folder.

According to an embodiment, the user may index the content 140 uploaded through the chat room interface 120. The user terminal 110 may receive a first user input 130 associated with a request to index content, and the content 140. The user terminal 110 may receive a second user input 150 associated with indexing the received content 140. In this case, the received content 140 may be stored in a folder corresponding to either the first user input 130 or the second user input 150 and indexed. The folder corresponding to either the first user input 130 or the second user input 150 may be a folder associated with the chat room (e.g., an album folder in the chat room). In an embodiment, the folder corresponding to either the first user input 130 or the second user input 150 may be a folder associated with the instant messaging service.

The first user input 130 and the second user input 150 may be a predefined indicator or sticker provided by the instant messaging service. The sticker may include text or images associated with content indexing. Additionally, the user may edit or customize the text or images of the sticker to predefine or indicate which is the folder for storing the content. The folder for storing the content through indexing may be a pre-generated folder. However, in some examples, when the sticker is input or provided, a folder for storing content associated with the sticker may be generated.

If the user uploads the content 140 to the chat room to share it with other users, a second user may upload other content after the first user input 130. In this case, between the first user input 130 and the second user input 150, both the content uploaded by the user and the content uploaded by the second user may be indexed and stored in the folder. According to an embodiment, it may be possible to navigate to or check the indexed content not only on the user terminal of the user who participated in the chat room when the content was uploaded, but also on the user terminal of the second user.

The content 140 may be indexed through the first user input 130. For example, if a plurality of pieces of content are received after the first user input 130, a folder corresponding to the first user input 130 may be determined to store a predetermined number of pieces of content from among the received content. For example, in a case in which the predetermined number of pieces of content is two, if the user uploads a plurality of pieces of content to the chat room after the first user input 130, a folder corresponding to the first user input 130 may be determined to store two pieces of content after the first user input 130. Accordingly, the plurality of pieces of content after the first user input 130 may be indexed in a folder corresponding to the first user input 130.

The folder corresponding to the first user input 130 may be determined to store content received within a predetermined time after the first user input 130. For example, in a case in which the predetermined time is 3 hours, if the user uploads first and second videos to the chat room after the first user input 130, and then uploads a third video to the chat room after 3 hours, a folder corresponding to the first user input 130 may be determined to store the first and second videos. Accordingly, only the first and second videos may be indexed in the folder corresponding to the first user input 130.

The content 140 may be indexed through the second user input 150. For example, if the second user input 150 is received after the plurality of pieces of content 140 are received, a folder corresponding to the second user input 150 may be determined to store a predetermined number of pieces of content from among the received content. For example, if the second user input 150 is received after the user uploads a plurality of pieces of content to the chat room, a folder corresponding to the second user input 150 may be determined to store two pieces of content that are received immediately before the second user input 150. Accordingly, the two pieces of content that are received immediately before the second user input 150 may be indexed in the folder corresponding to the second user input 150.

The folder corresponding to the second user input 150 may be determined to store the content associated with the second user input 150 among the content 140 received before the second user input 150 is received. For example, if the folder corresponding to the second user input 150 is a “Shopping List” folder, and if a first link, a second link, and a third link are received before the second user input 150 is received, only the third link may be associated with the “Shopping List” folder. In this case, the folder corresponding to the second user input 150 may be determined to store, from among the received content, the third link associated with the second user input 150. Accordingly, the third link may be indexed in the “Shopping List” folder.

By indexing the content uploaded in the instant messaging service according to the method described above, the user may easily navigate to the stored content later. In addition, in the process of indexing content, the user may efficiently index a plurality of pieces of content using predefined indicators or stickers. In addition, it is possible to efficiently use computing resources that would otherwise be redundantly used for indexing each piece of content.

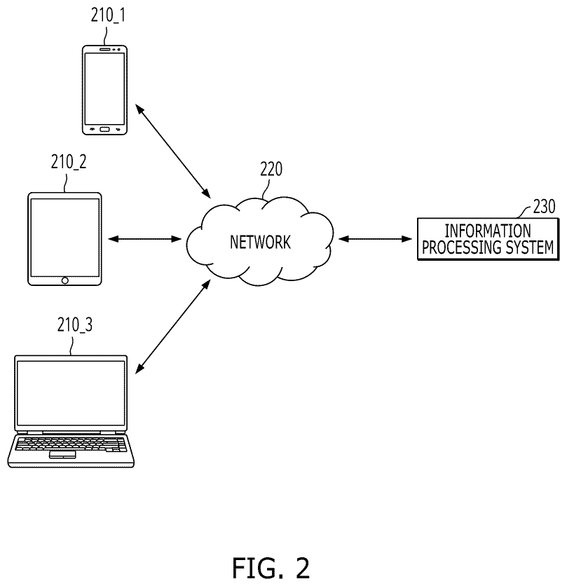

FIG. 2 is a schematic diagram illustrating a configuration in which an information processing system 230 is communicatively connected to a plurality of user terminals 210_1, 210_2, and 210_3 to index content in the instant messaging service. As illustrated, the plurality of user terminals 210_1, 210_2, and 210_3 may be connected to the information processing system 230 that is capable of providing an instant messaging service or an associated content indexing service through a network 220. The plurality of user terminals 210_1, 210_2, and 210_3 may include a user terminal provided with the instant messaging service or the associated content indexing service.

The information processing system 230 may include one or more server devices and/or databases capable of storing, providing, and executing computer-executable programs (e.g., downloadable applications) and data associated with providing the instant messaging service or the associated content indexing service, or one or more distributed computing devices and/or distributed databases based on cloud computing services.

The instant messaging service or the associated content indexing service provided by the information processing system 230 may be provided to the user through the instant messaging application, etc. installed in each of the plurality of user terminals 210_1, 210_2, and 210_3. For example, the information processing system 230 may index the content uploaded to the chat room through the instant messaging application, etc.

The plurality of user terminals 2101, 210_2, and 210_3 may communicate with the information processing system 230 through the network 220. The network 220 may be configured to enable communication between the plurality of user terminals 2101, 210_2, and 210_3 and the information processing system 230. The network 220 may be configured as a wired network such as Ethernet, a wired home network (Power Line Communication), a telephone line communication device and RS-serial communication, a wireless network such as a mobile communication network, a wireless LAN (WLAN), Wi-Fi, Bluetooth, and ZigBee, or a combination thereof, depending on the installation environment. The method of communication may include a communication method using a communication network (e.g., mobile communication network, wired Internet, wireless Internet, broadcasting network, satellite network, etc.) that may be included in the network 220 as well as short-range wireless communication between the user terminals 210_1, 210_2, and 2103, but aspects are not limited thereto.

In FIG. 2, a mobile phone terminal 210_1, a tablet terminal 210_2, and a PC terminal 210_3 are illustrated as the examples of the user terminals, but aspects are not limited thereto, and the user terminals 2101, 210_2, and 210_3 may be any computing device that is capable of wired and/or wireless communication and that can be installed with the instant messaging application, the web browser, etc. and execute the same. For example, the user terminal may include an AI speaker, a smart phone, a mobile phone, a navigation, a computer, a notebook, a digital broadcasting terminal, a personal digital assistant (PDA), a portable multimedia player (PMP), a tablet PC, a game console, a wearable device, an internet of things (IoT) device, a virtual reality (VR) device, an augmented reality (AR) device, a set-top box, etc. In addition, FIG. 2 illustrates that three user terminals 210_1, 210_2, and 210_3 are in communication with the information processing system 230 through the network 220, but aspects are not limited thereto, and a different number of user terminals may be configured to be in communication with the information processing system 230 through the network 220.

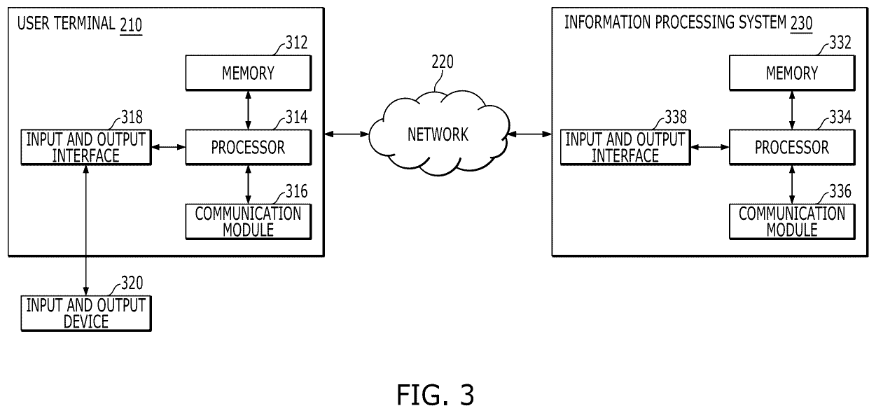

FIG. 3 is a block diagram of an internal configuration of the user terminal 210 and the information processing system 230. The user terminal 210 may refer to any computing device that is capable of executing the application, web browsers, etc., and also capable of wired/wireless communication, and may include the mobile phone terminal 210_1, the tablet terminal 210_2, and the PC terminal 210_3 of FIG. 2, for example. As illustrated, the user terminal 210 may include at least one of a memory 312, a processor 314, a communication module 316, and an input/output interface 318. Likewise, the information processing system 230 may include at least one of a memory 332, a processor 334, a communication module 336, and an input/output interface 338. As illustrated in FIG. 3, the user terminal 210 and the information processing system 230 may be configured to communicate information, data, etc. through the network 220 using the respective communication modules 316 and 336. In addition, an input/output device 320 may be configured to input information, data, etc. to the user terminal 210, or output information, data, etc. generated from the user terminal 210 through the input/output interface 318.

The memories 312 and 332 may include any non-transitory computer-readable recording medium. The memories 312 and 332 may include a permanent mass storage device such as read-only memory (ROM), disk drive, solid state drive (SSD), flash memory, etc. According to an embodiment, a non-destructive mass storage device such as ROM, SSD, flash memory, disk drive, etc. may be included in the user terminal 210 or the information processing system 230 as a separate permanent storage device that is distinct from the memory. In addition, an operating system and at least one program code may be stored in the memories 312 and 332.

These software components may be loaded from a computer-readable recording medium separate from the memories 312 and 332. Such a separate computer-readable recording medium may include a recording medium directly connectable to the user terminal 210 and the information processing system 230, and may include a computer-readable recording medium such as a floppy drive, a disk, a tape, a DVD/CD-ROM drive, a memory card, etc., for example. According to an embodiment, the software components may be loaded into the memories 312 and 332 through the communication modules 316 and 336 rather than the computer-readable recording medium. For example, at least one program may be loaded into the memories 312 and 332 based on a computer program installed by files provided by developers or a file distribution system that distributes an installation file of an application through the network 220.

The processors 314 and 334 may be configured to process the commands of the computer program by performing basic arithmetic, logic, and input/output operations. The commands may be provided to the processors 314 and 334 from the memories 312 and 332 or the communication modules 316 and 336. For example, the processors 314 and 334 may be configured to execute the received commands according to a program code stored in a recording device such as the memories 312 and 332.

The communication modules 316 and 336 may provide a configuration or function for the user terminal 210 and the information processing system 230 to communicate with each other through the network 220, and may provide a configuration or function for the user terminal 210, the information processing system 230, etc. to communicate with another user terminal or another system (e.g., a separate cloud system, etc.). For example, a request or data (e.g., a request to index content, content, etc.) generated by the processor 314 of the user terminal 210 according to a program code stored in a recording device such as the memory 312 may be transmitted to the information processing system 230 through the network 220 under the control of the communication module 316. Conversely, a control signal or command provided under the control of the processor 334 of the information processing system 230 may be sent through the communication module 336 and the network 220 and received by the user terminal 210 through the communication module 316 of the user terminal 210. The communication modules 316 and 336 may be also referred to as communication interfaces, and may be implemented by any one or any combination of a digital modem, a radio frequency (RF) modem, an antenna circuit, a WiFi chip, and related software and/or firmware.

The input/output interface 318 may configured to interface with the input/output device 320. According to an embodiment, the input device may include a device such as a camera including an audio sensor and/or an image sensor, a keyboard, a microphone, a mouse, etc., and the output device may include a device such as a display, a speaker, a haptic feedback device, etc. According to an embodiment, the input/output interface 318 may include a device such as a touch screen, etc. that incorporates a configuration or function for performing inputting and outputting. For example, when the processor 314 of the user terminal 210 processes the commands of the computer program loaded into the memory 312, a service screen, etc., which is configured with the information, data, etc. provided by the information processing system 230 or another user terminals, may be displayed on the display through the input/output interface 318. While FIG. 3 illustrates that the input/output device 320 is not included in the user terminal 210, aspects are not limited thereto, and the input/output device may be configured as one device with the user terminal 210. In addition, the input/output interface 338 of the information processing system 230 may interface with a device for inputting or outputting, which may be connected to or included in the information processing system 230. While FIG. 3 illustrates the input/output interfaces 318 and 338 as the components configured separately from the processors 314 and 334, aspects are not limited thereto, and the input/output interfaces 318 and 338 may be configured to be included in the processors 314 and 334.

The user terminal 210 and the information processing system 230 may include more components than those illustrated in FIG. 3. Some of the related components may not necessarily require exact illustration. The user terminal 210 may include at least a part of the input/output device 320 described above. In addition, the user terminal 210 may further include another component such as a transceiver, a global positioning system (GPS) module, a camera, various sensors, a database, etc. For example, if the user terminal 210 is a smartphone, it may include components generally included in the smartphone. For example, a smartphone may be implemented with various components such as an acceleration sensor, a gyro sensor, a microphone module, a camera module, various physical buttons, buttons using a touch panel, input/output ports, a vibrator for vibration, etc. that are further included in the user terminal 210.

While the program for the instant messaging application, etc. providing the instant messaging service including content indexing functionality is operating, the processor 314 may receive text, image, video, voice and/or operation, etc. input or selected through an input device such as a camera, microphone, including a touch screen, keyboard, audio sensor and/or image sensor connected to the input/output interface 318, and may store the received text, image, video, voice, and/or operation, etc. in the memory 312 or may be provide the same to the information processing system 230 through the communication module 316 and the network 220.

The processor 314 of the user terminal 210 may be configured to manage, process and/or store the information, data, etc. received from the input/output device 320, another user terminal, the information processing system 230, a plurality of external systems, etc. The information, data, etc. processed by the processor 314 may be provided to the information processing system 230 through the communication module 316 and the network 220. The processor 314 of the user terminal 210 may send the information, data, etc. to the input/output device 320 through the input/output interface 318 to output the same. For example, the processor 314 may display the received information, data, etc. on a screen of the user terminal 210.

The processor 334 of the information processing system 230 may be configured to manage, process, and/or store information, data, etc. received from a plurality of user terminals 210, a plurality of external systems, etc. The information, data, etc. processed by the processor 334 may be provided to the user terminals 210 through the communication module 336 and the network 220.

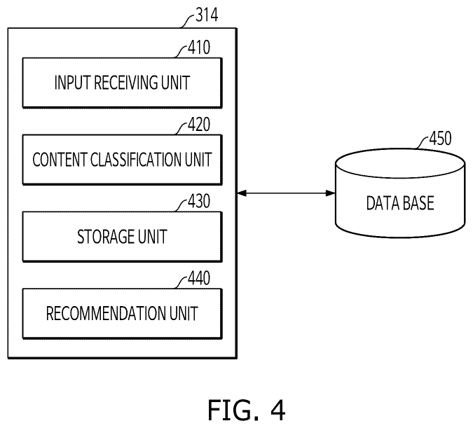

FIG. 4 is a block diagram illustrating an internal configuration of the processor 314. As illustrated, the processor 314 may include an input receiving unit 410, a content classification unit 420, a storage unit 430, and a recommendation unit 440.

The input receiving unit 410 may detect and receive a user input associated with content and/or a user input associated with content indexing. If the user input (e.g., sticker input, touch input, content input, etc.) is associated with content indexing, the input receiving unit 410 may transmit the received user input associated with content indexing (e.g., a first user input received before content input, a second user input received after content input) and content data to the content classification unit 420. According to an embodiment, the input receiving unit 410 may transmit the received user input and content to the recommendation unit 440.

The content classification unit 420 may classify the content received from the input receiving unit 410 according to its content or type. For example, the content classification unit 420 may classify the received content in a folder corresponding to the received user input (e.g., the first user input or the second user input) according to the content of the content. For example, if the folder corresponding to the second user input is a “Yoube Links” folder, the content classification unit 420 may determine that the received content is to be stored in the “Yoube Links” folder. According to an embodiment, the content classification unit 420 may classify the received content into links, images, videos, etc., according to its type. For example, if the received content is an image, the content classification unit 420 may determine that the received content is to be stored in an image folder. Additionally, the content classification unit 420 may transmit information associated with determining the storage folder of the content to the storage unit 430.

In response to receiving the information associated with determining the storage folder from the content classification unit 420, the storage unit 430 may store the content received from the content classification unit 420 in the determined folder. For example, if the storage folder of the received content is determined to be the “Yoube Links” folder, the storage unit 430 may store the content in the “Yoube Links” folder. According to an embodiment, if the storage folder of the received content is determined to be the image folder, the storage unit 430 may store the content in the image folder. Additionally, the content may be stored in a database 450.

The recommendation unit 440 may recommend, based on the content received from the input receiving unit 410, a folder for storing the content or a sticker for storing the content. The recommendation unit 440 may classify the content or type of the content received between the first user input and the second user input through a pre-trained content classification model, and recommend a folder or sticker where the content is to be stored according to the classified content or type. The pre-trained content classification model may be a model trained to analyze metadata, etc. included in the content and classify the content into videos, images, links, etc. According to an embodiment, the pre-trained content classification model may be a model trained to analyze object information, place information, etc. included in the content and classify the content (e.g., travel, cafe, etc.) associated with the content. For example, the content classification model may be an artificial neural network-based model or statistical probability-based model that is trainable to classify the content or type of the input content, but is not limited thereto.

The folder recommended by the recommendation unit 440 may be a pre-generated folder. According to an embodiment, if there is no folder for storing the content, the recommendation unit 440 may generate and recommend a folder for storing the content through indexing or may recommend generating a folder for storing the content through indexing. In addition, the sticker recommended by the recommendation unit 440 may be a sticker owned by the user, which may have been purchased or obtained in advance. According to an embodiment, the recommendation unit 440 may recommend a sticker that is not currently owned by the user to encourage the purchase of a paid sticker by the user.

The internal configuration of the processor 314 illustrated in FIG. 4 is only an example, and in some examples, configurations other than the illustrated internal configuration may be additionally included, or some configurations may be omitted, or some processes may be performed by other configurations or external systems. For example, at least some functions of the content classification unit, the storage unit, or the recommendation unit may be performed by the processor 334 of the information processing system 230. In addition, although the internal components of the processor 314 are described separately for each function in FIG. 4, the internal components may not be physically separated. For example, each block or unit may be physically separated into two or more interacting and discrete blocks or units without departing from the present scope. Further, the blocks or units may be physically combined into more complex blocks or units without departing from the present scope.

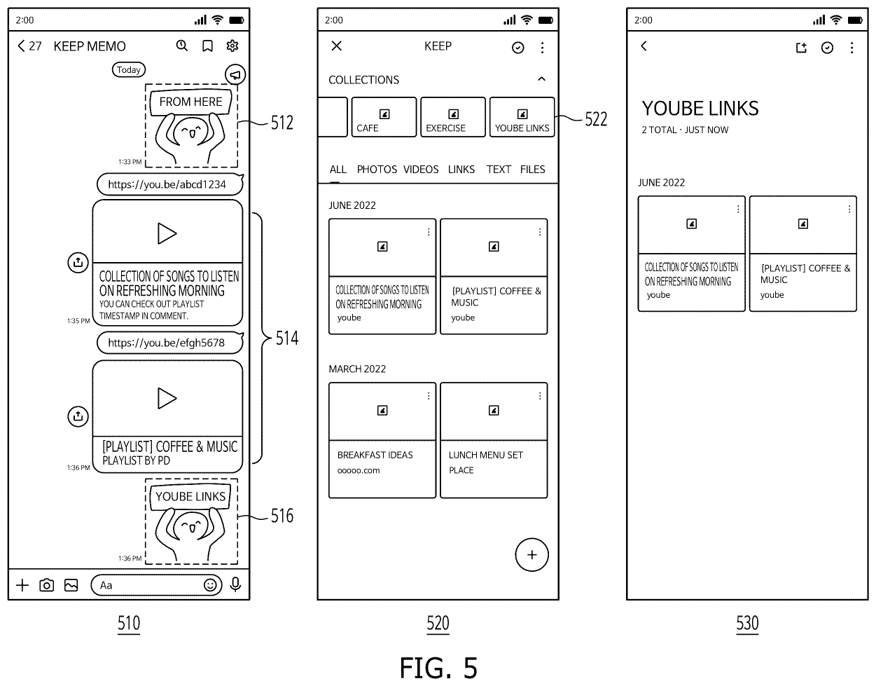

FIG. 5 is a diagram illustrating an example of indexing the content according to an embodiment. The user terminal or the processor may index the content uploaded or shared in the chat room of the instant messaging application through a first operation 510, a second operation 520, and a third operation 530. The first operation 510 represents an example in which the user indexes the content in the personal chat room (e.g., “Keep Memo” chat room). As illustrated, the user terminal or the processor may initiate indexing the content in response to receiving a first user input (or a first sticker 512) associated with content indexing in the “Keep Memo” chat room. The first sticker 512 may be associated with a request to index content. Additionally, the first sticker 512 may be associated with the folder for storing the content. In this case, the folder for storing the content may vary according to the type of the first sticker 512.

After the user inputs the first sticker, the user may upload content 514 to be stored in the “Keep Memo” chat room. The content 514 may include at least one of text, a link, an image, or a video. Although FIG. 5 illustrates that the user uploaded the content 514 in the personal chat room, aspects are not limited thereto. For example, the content to be stored in the chat room where the current user and one or more other users participate may include content uploaded by the user other than the current user.

Through a second user input (or a second sticker 516) for indexing the content, the user may cause the uploaded content 514 to be indexed so that the indexed content may be stored according to an appropriate classification method. The second sticker 516 may be associated with a folder for storing the content. For example, if the second sticker 516 is associated with a “Yoube Links” folder 522, the content 514 uploaded by the user may be stored in the “Yoube Links” folder 522. The folder for storing the content may vary according to the type of the second sticker 516. Additionally, the content uploaded from the chat room where the user and other users participate together may be stored in a folder of each of the users in the chat room.

If the user inputs an additional sticker (i.e., a third sticker) for indexing the content, the content 514 may be indexed and stored based on the third sticker. The third sticker may be associated with a sub-folder for storing the content. For example, if the third sticker is associated with a “Jazz” folder, in response to the user inputting the third sticker, the content may be stored in the “Jazz” folder, which is a sub-folder of the folder corresponding to the first or second sticker. That is, if the second sticker 516 is associated with the “Yoube Links” folder 522, the content may be stored in the “Jazz” folder, which is a sub-folder of the “Yoube Links” folder 522.

If the content to be stored is an image or a video, the folder for storing the content may be a sub-folder of an album. The album refers to an album provided by the instant messaging service (i.e., a virtual album that may store images or videos, etc.), which may be associated with a specific chat room. The content may be stored in a sub-folder of the album according to a specific event (e.g., date, place, etc.).

FIG. 5 illustrates that a folder for storing the content 514 is determined in response to inputting the second sticker 516, but the folder for storing the content 514 may also be determined based on the first sticker 512. For example, if the first sticker 512 includes text or images associated with a “Travel” folder, the content 514 uploaded by the user may be stored in the “Travel” folder.

The user may execute a user input for the content to designate a folder for storing the content. For example, by selecting content displayed on the display of the user terminal through double or long touch input, etc., the user may directly set a folder for storing the content. In this case, the content may be stored in the folder set by the user.

The second operation 520 is an example illustrating a list of folders for storing content according to an embodiment. In the first operation 510, the user may select a menu item of the chat room interface through a touch input, etc., and switch to the second operation 520. The user may generate or check a folder for storing the content according to the content of the content. For example, the user may generate a folder associated with cafe, exercise, etc. and store content in each folder. In addition, the user may check the folder for storing the content according to the type of the content. For example, the user may check the stored content according to the type of the content, such as photographs, videos, links, texts, files, etc.

The third operation 530 is an example in which the folder is output on the display of the user terminal in response to the user selecting the folder 522 storing the content with a touch input, etc. in the second operation 520. The user may check again the content 514 uploaded and stored in the chat room in the folder 522. Additionally, the user may switch to the third operation 530 by selecting the second sticker 516 with a touch input, etc. in the first operation 510.

The content 514 may be indexed through the first sticker 512. For example, if a plurality of pieces of content 514 are received after the input of the first sticker 512, a folder corresponding to the first sticker 512 may be determined to store a predetermined number of pieces of content from among the received content 514, even if the second sticker 516 is not input. For example, in a case in which the predetermined number of pieces of content is two, if the user uploads the plurality of pieces of content 514 to the chat room after the input of the first sticker 512, a folder corresponding to the first sticker 512 may be determined to store two pieces of content received after the input of the first sticker 512. Accordingly, the two pieces of content received after the input of the first sticker 512 may be indexed in the folder corresponding to the first sticker 512.

Even if the second sticker 516 is not input, the folder corresponding to the first sticker 512 may be determined to store the content received within a predetermined time after the input of the first sticker 512. For example, in a case in which the predetermined time is 3 hours, if the user uploads first and second videos to the chat room after inputting the first sticker 512, and then uploads the third video to the chat room after 3 hours, a folder corresponding to the first sticker 512 may be determined to store only the first and second videos. Accordingly, the first and second videos may be indexed in the folder corresponding to the first sticker 512.

The content 514 may be indexed through the second sticker 516 even if the first sticker 512 is not input. If the second sticker 516 is received after the plurality of pieces of content 514 are received, a folder corresponding to the second sticker 516 may be determined to store a predetermined number of pieces of content from among the received content 514. For example, if the second sticker 516 is received after the user uploads the plurality of pieces of content 514 to the chat room, a folder corresponding to the second sticker 516 may be determined to store two pieces of content that are received immediately before the second sticker 516. Accordingly, only the two pieces of content that are received immediately before the second sticker 516 may be indexed in the folder corresponding to the second sticker 516.

Even if the first sticker 512 is not input, a folder corresponding to the second sticker 516 may be determined to store content associated with the second sticker 516 from among the content 514 received before the second sticker 516 is received. For example, if the folder corresponding to the second sticker 516 is the “Shopping List” folder, and the first link, the second link, and the third link are received before the second sticker 516 is received, only the third link may be associated with the “Shopping List” folder. In this case, the folder corresponding to the second sticker 516 may be determined to store, from among the received content, the third link associated with the second sticker 516. Accordingly, the third link may be indexed in the “Shopping List” folder.

According to an embodiment, it may be possible to efficiently index the content through a predefined sticker in the instant messaging service. Accordingly, the user may easily navigate to the indexed content in the instant messaging service later. In addition, if the content is shared in a multi-user chat room provided by the instant messaging service, by indexing the content through a sticker and storing the content in association with an account or folder assigned to each user in the chat room, the user can easily share the content with other users and navigate to the content.

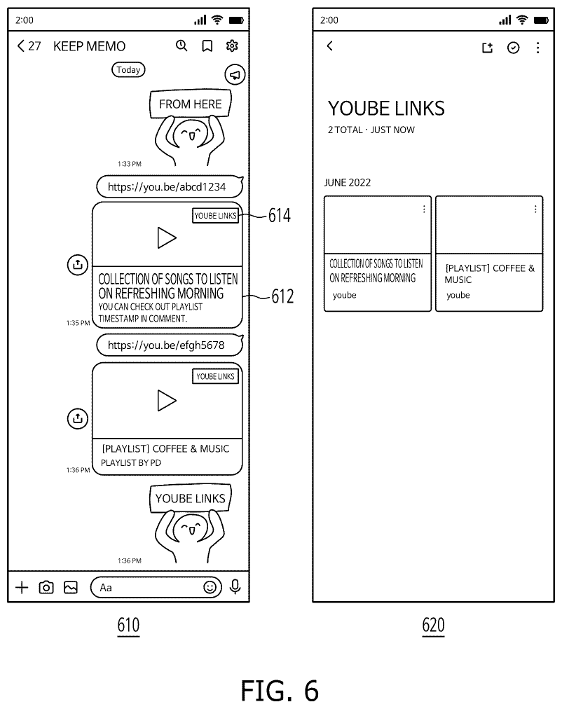

FIG. 6 is a diagram illustrating an example of displaying, on content 612, a badge 614 associated with a sticker after content indexing. A first operation 610 is an example in which the badge 614 is displayed on the uploaded content 612 after the user indexes the content 612 uploaded in the “Keep Memo” chat room. The badge 614 may be associated with a sticker input by the user for content indexing. That is, the badge 614 may be associated with the folder where the content 612 is stored. For example, if the user stores the uploaded content 612 in the “Yoube Links” folder through sticker input, the “Yoube Links” badge 614 may be displayed in a specific area of the uploaded content 612. As a result, the user may easily check in the chat room interface which folder the indexed content is stored in.

A second operation 620 represents an example in which a folder associated with the badge 614 is output on the display of the user terminal in response to the user selecting the badge 614 with a touch input, etc. The user may select the badge 614 to navigate to the folder where the content is stored. In this case, the user may check other content stored in the folder together.

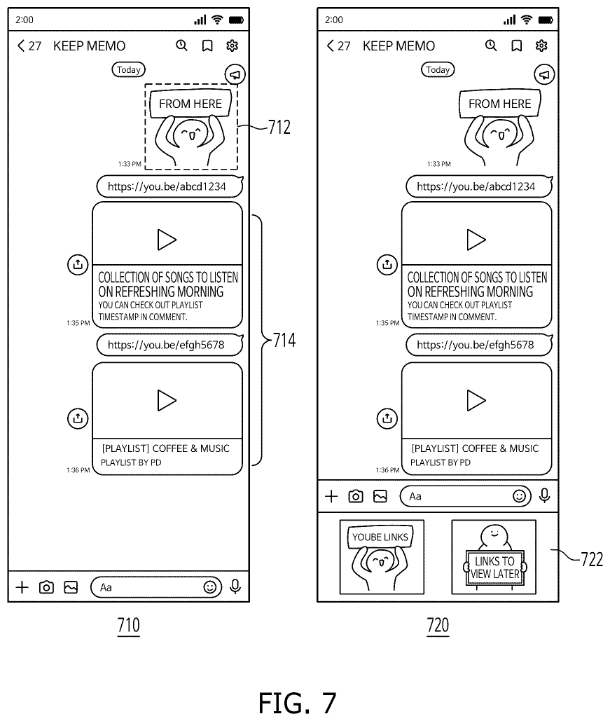

FIG. 7 is a diagram illustrating an example of recommending a sticker for content indexing. The user may be provided with a recommendation of a sticker for content indexing through a first operation 710 and a second operation 720. The first operation 710 is an example illustrating a process in which the user indexes content 714 in the “Keep Memo” chat room. The user may initiate content indexing through a first sticker 712. The user may upload the content 714 to be indexed to the chat room.

The second operation 720 is an example of recommending a second sticker 722 for indexing the content 714 to the user. The recommended second sticker 722 may be determined based on the content 714. In this case, the second sticker 722 may be determined through a pre-trained content classification model. The pre-trained content classification model may analyze metadata, object information, time information, place information, etc. included in or associated with the content 714 to classify the content according to its content and type, and determine a folder for storing the content 714. For example, by analyzing the metadata of the content 714, etc. uploaded by the user, the pre-trained content classification model may determine that the content 714 is to be stored in the “Yoube Links” folder. In this case, the pre-trained classification model may determine to recommend a sticker associated with the “Yoube Links” folder.

In response to the content being classified, the second sticker 722 associated with the folder for storing the content may be recommended. The recommended second sticker 722 may be a sticker based on the determination of the pre-trained content classification model. In this case, the recommended second sticker 722 may be a sticker owned by the user. According to an embodiment, the recommended second sticker 722 may be a sticker that is not currently owned by the user, and may be recommended to encourage the purchase of a paid sticker by the user.

Instead of recommending the second sticker 722, a folder for storing the content may be recommended. In this case, the user may execute a user input on the content to store the content in the recommended folder. For example, in response to the user selecting the content through a double or long touch input, etc., the content may be stored in the recommended folder. If the recommended folder has not been generated, the folder may be generated and the content may be stored in the generated folder.

When uploading or sharing content in the instant messaging service, a sticker for indexing the content may be recommended. Using the recommended sticker, the user may easily classify or index the content. In addition, the purchase of paid stickers for content indexing may naturally be encouraged in the instant messaging service.

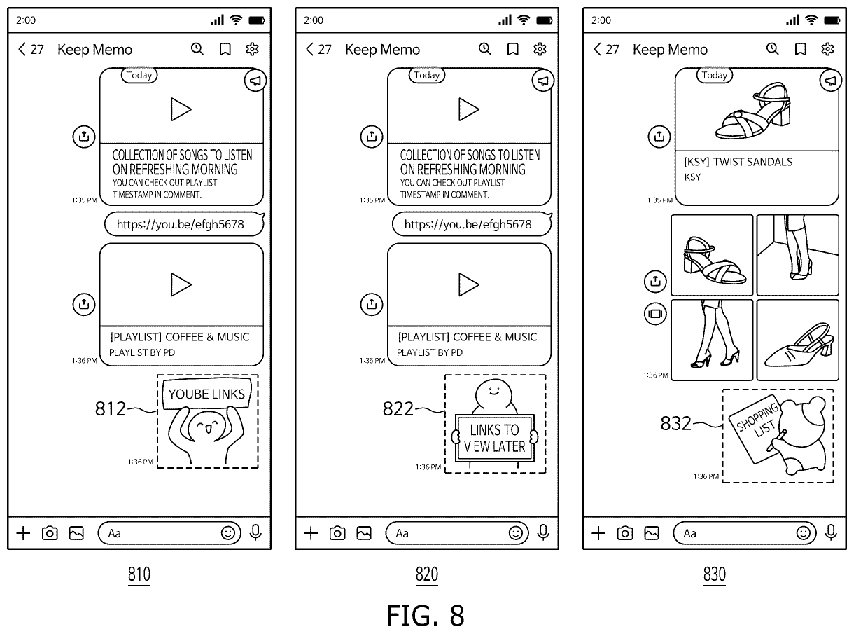

FIG. 8 is a diagram illustrating an example in which the user customizes the sticker for content indexing. As illustrated in a first operation 810, a second operation 820, and a third operation 830, the user may input different types of stickers for content indexing. The folder for storing the content may be determined differently based on the type of sticker input by the user. For example, a first sticker 812 may be associated with the “Yoube Links” folder, and a third sticker 832 may be associated with the “Shopping List” folder.

If the user purchases a sticker, a folder associated with the purchased sticker may be set. If the folder has not been generated, the user may generate a folder and set the generated folder as a folder associated with the purchased sticker. In addition, the user may later change the folder associated with the sticker to a different folder.

The user may edit or customize the sticker for content indexing. The sticker for content indexing may include text or images associated with indexing. In this case, the user may input or change the text or images associated with indexing. For example, the user may change the first sticker 812 associated with the “Yoube Links” folder to a second sticker 822. In this case, the “Yoube Links” folder for storing the content may be maintained as is. Accordingly, the user may store the content in the “Yoube Links” folder using the second sticker 822.

With such a configuration, according to various aspects, the user may customize the sticker for content indexing in the instant messaging service. Accordingly, the user may use the customized sticker reflecting their preferences when executing content indexing of content. In addition, the user may more efficiently index content by using stickers that are convenient for them.

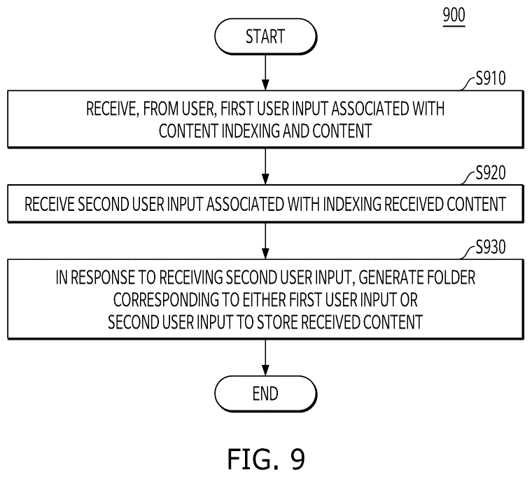

FIG. 9 is a flowchart provided to explain an example of a method 900 for indexing content in the instant messaging service. The method 900 may be performed by one or more processors of the user terminal. The method 900 may be initiated by receiving a first user input associated with content indexing and content from the user, at S910. The first user input may be received through a specific chat room provided by the instant messaging service. In addition, the content may include at least one of text, a link, an image, or a video. Additionally, the content may include content received from a user other than the current user.

The processor may receive a second user input associated with indexing the received content, at S920. In response to receiving the second user input, the processor may generate a folder corresponding to either the first user input or the second user input to store the received content, at S930. If the content is an image or a video, the folder for storing the content may be a sub-folder of the album.

The second user input may be a sticker provided by the instant messaging service. The sticker may include text or images associated with indexing the content. In this case, the text or images may be capable of being input or changed by the user. In addition, a folder corresponding to either the first user input or the second user input may be determined based on the type of the sticker. According to an embodiment, the second user input may be a user input executed on the content to designate a folder for storing the content.

The processor may receive a third user input associated with indexing the received content. In addition, in response to receiving the third user input, the processor may determine a sub-folder corresponding to the third user input within the folder corresponding to the first or second user input to store the received content.

The processor may display a badge associated with the sticker on the received content. In addition, if the user selects a badge associated with the sticker, the processor may output, on the display of the user terminal, a folder corresponding to the badge associated with the sticker.

The processor may recommend a folder for storing the content based on the received content. For example, the processor may recommend, based on the received content, at least one sticker associated with the folder for storing the content. In this case, the recommended at least one sticker may be a sticker owned by the user.

The first user input, the content, and the second user input may be received through a specific chat room provided by the instant messaging service, and the folder corresponding to either the first user input or the second user input may be associated with the chat room. For example, the folder corresponding to either the first user input or the second user input may be associated with the instant messaging service.

According to an embodiment, the method for indexing content may be initiated by receiving a third user input associated with content indexing and the content from the user. In response to receiving the content, the processor may determine a folder corresponding to the third user input or the content to store the received content. In this case, the processor may determine the folder corresponding to the third user input to store a predetermined number of pieces of content from among the received content. For example, the processor may determine the folder corresponding to the third user input to store the content received within a predetermined time after the third user input from among the received content.

According to an embodiment, the method for indexing content may be initiated by receiving the content from the user. The processor may receive a fourth user input associated with indexing the received content. In response to receiving the fourth user input, the processor may determine a folder corresponding to the fourth user input or the content to store the received content. In this case, the processor may determine the folder corresponding to the fourth user input to store a predetermined number of pieces of content from among the received content. According to an embodiment, the processor may determine the folder corresponding to the fourth user input to store the content associated with the fourth user input from among the received content.

The method described above may be provided as a computer program stored in a computer-readable recording medium for execution on a computer. The medium may be a type of medium that continuously stores a program executable by a computer, or temporarily stores the program for execution or download. In addition, the medium may be a variety of recording means or storage means having a single piece of hardware or a combination of several pieces of hardware, and is not limited to a medium that is directly connected to any computer system, and accordingly, may be present on a network in a distributed manner. An example of the medium includes a medium configured to store program instructions, including a magnetic medium such as a hard disk, a floppy disk, and a magnetic tape, an optical medium such as a CD-ROM and a DVD, a magneto-optical medium such as a floptical disk, a ROM, a RAM, a flash memory, etc. In addition, other examples of the medium may include an app store that distributes applications, a site that supplies or distributes various software, and a recording medium or a storage medium managed by a server.

The methods, operations, or techniques of the present disclosure may be implemented by various means. For example, these techniques may be implemented in hardware, firmware, software, or a combination thereof. Those skilled in the art will further appreciate that various illustrative logical blocks, modules, circuits, and algorithm steps described in connection with the disclosure herein may be implemented in electronic hardware, computer software, or combinations of both. To clearly illustrate this interchangeability of hardware and software, various illustrative components, blocks, modules, circuits, and steps have been described above generally in terms of their functionality. Whether such a function is implemented as hardware or software depends on design requirements imposed on the particular application and the overall system. Those skilled in the art may implement the described functions in varying ways for each particular application, but such implementation should not be interpreted as causing a departure from the scope of the present disclosure.

In a hardware implementation, processing units used to perform the techniques may be implemented in one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the present disclosure, computer, or a combination thereof.

Accordingly, various example logic blocks, modules, and circuits described in connection with the present disclosure may be implemented or performed with general purpose processors, DSPs, ASICs, FPGAs or other programmable logic devices, discrete gate or transistor logic, discrete hardware components, or any combination of those designed to perform the functions described herein. The general purpose processor may be a microprocessor, but in the alternative, the processor may be any related processor, controller, microcontroller, or state machine. The processor may also be implemented as a combination of computing devices, for example, a DSP and microprocessor, a plurality of microprocessors, one or more microprocessors associated with a DSP core, or any other combination of the configurations.

In the implementation using firmware and/or software, the techniques may be implemented with commands stored on a computer-readable medium, such as random access memory (RAM), read-only memory (ROM), non-volatile random access memory (NVRAM), programmable read-only memory (PROM), erasable programmable read-only memory (EPROM), electrically erasable PROM (EEPROM), flash memory, compact disc (CD), magnetic or optical data storage devices, etc. The commands may be executable by one or more processors, and may cause the processor(s) to perform certain aspects of the functions described in the present disclosure.

When implemented in software, the techniques may be stored on a computer-readable medium as one or more commands or codes, or may be transmitted through a computer-readable medium. The computer-readable media include both the computer storage media and the communication media including any medium that facilitates the transmission of a computer program from one place to another. The storage media may also be any available media that may be accessible to a computer. By way of non-limiting example, such a computer-readable medium may include RAM, ROM, EEPROM, CD-ROM or other optical disk storage, magnetic disk storage or other magnetic storage devices, or any other media that can be used to transmit or store desired program code in the form of commands or data structures and can be accessible to a computer. In addition, any connection is properly referred to as a computer-readable medium.

For example, if the software is sent from a website, server, or other remote sources using coaxial cable, fiber optic cable, twisted pair, digital subscriber line (DSL), or wireless technologies such as infrared, wireless, and microwave, the coaxial cable, the fiber optic cable, the twisted pair, the digital subscriber line, or the wireless technologies such as infrared, wireless, and microwave are included within the definition of the medium. The disks and the discs used herein include CDs, laser disks, optical disks, digital versatile discs (DVDs), floppy disks, and Blu-ray disks, where disks usually magnetically reproduce data, while discs optically reproduce data using a laser. The combinations described above should also be included within the scope of the computer-readable media.

The software module may reside in RAM memory, flash memory, ROM memory, EPROM memory, EEPROM memory, registers, hard disk, removable disk, CD-ROM, or any other form of storage medium known. An example storage medium may be connected to the processor such that the processor may read or write information from or to the storage medium. According to an embodiment, the storage medium may be integrated into the processor. The processor and the storage medium may be present in the ASIC. The ASIC may be present in the user terminal. According to an embodiment, the processor and storage medium may exist as separate components in the user terminal.

Although the examples described above have been described as utilizing the aspects of the currently disclosed subject matter in one or more standalone computer systems, aspects are not limited thereto, and may be implemented in conjunction with any computing environment, such as a network or distributed computing environment. Furthermore, the aspects of the subject matter in the present disclosure may be implemented in a plurality of processing chips or devices, and storage may be similarly influenced across a plurality of devices. Such devices may include PCs, network servers, and portable apparatus.

According to various aspects of the present disclosure, by indexing the content uploaded in the instant messaging service, the user can easily navigate to the stored content later. In addition, in the process of indexing content, the user can efficiently index a plurality of pieces of content using predefined indicators or stickers. In addition, it is possible to efficiently use computing resources that would otherwise be redundantly used for indexing each piece of content.

According to various aspects of the present disclosure, it is possible to efficiently index the content through a predefined sticker in the instant messaging service. Accordingly, the user can easily navigate to the indexed content in the instant messaging service later. In addition, if the content is shared in a multi-user chat room provided by the instant messaging service, by indexing the content through a sticker and storing the content in association with an account or folder assigned to each user in the chat room, the user can easily share the content with other users and navigate through the content.

According to various aspects of the present disclosure, when uploading or sharing the content in the instant messaging service, a sticker for indexing the content can be recommended. Using the recommended sticker, the user can easily classify or index the content. In addition, the purchase of paid stickers for content indexing can naturally be encouraged in the instant messaging service.

According to various aspects of the present disclosure, the user can customize the sticker for content indexing in the instant messaging service. Accordingly, the user can use the customized sticker reflecting their preferences when executing content indexing. In addition, the user can more efficiently index the content by using stickers that are convenient for them.

The effects of the present disclosure are not limited to the effects described above, and other effects not described herein can be clearly understood by those of ordinary skill in the art (referred to as “ordinary technician”) from the description of the claims.

Although the present disclosure has been described herein in connection with some aspects, various modifications and changes can be made without departing from the scope of the present disclosure, which can be understood by those skilled in the art to which the present disclosure pertains. In addition, such modifications and changes should be considered within the scope of the claims appended herein.

1. A method for indexing content in an instant messaging service, the method being performed by one or more processors of a user terminal and comprising:
receiving, from a user, a first user input corresponding to a request for content indexing, and a content;
receiving a second user input to cause an indexing of the received content; and
based on receiving the second user input, generating a folder corresponding to the first user input or the second user input, and storing the received content in the folder.

2. The method according to claim 1, wherein the first user input is received through a chat room of the instant messaging service.

3. The method according to claim 1, wherein the content includes at least one of a text, a link, an image, or a video.

4. The method according to claim 1, wherein the second user input corresponds to a sticker included in the instant messaging service.

5. The method according to claim 4, wherein the sticker includes a text or an image corresponding to the indexing of the content.

6. The method according to claim 5, wherein the receiving the second input comprises receiving, from the user, an input of the text or the image of the sticker.

7. The method according to claim 4, wherein the folder corresponding to the first user input or the second user input is generated based on a type of the sticker.

8. The method according to claim 1, further comprising:
receiving a third user input to cause a second indexing of the received content; and
based on receiving the third user input, generating a sub-folder corresponding to the third user input and within the folder corresponding to the first user input or the second user input, and storing the received content in the sub-folder.

9. The method according to claim 4, further comprising displaying, on the received content, a badge corresponding to the sticker.

10. The method according to claim 9, further comprising, based on the user selecting the badge corresponding to the sticker, outputting a folder corresponding to the badge on a display of the user terminal.

11. The method according to claim 1, wherein, based on the content being an image or a video, the folder corresponding to the first user input or the second user input is generated as a sub-folder of an album.

12. The method according to claim 1, the receiving the second user input comprises receiving, on the content, a designation of a folder to be generated for storing the content.

13. The method according to claim 1, further comprising, based on the received content, providing a recommendation of a folder for storing the content.

14. The method according to claim 1, further comprising, based on the received content, providing a recommendation including at least one sticker corresponding to a folder for storing the content.

15. The method according to claim 14, wherein the at least one sticker included in the recommendation is a sticker purchased by the user.

16. The method according to claim 1, wherein the content is received from a second user, different from the user.

17. The method according to claim 1, wherein the first user input, the content, and the second user input are received through a chat room of the instant messaging service, and
wherein the folder corresponding to the first user input or the second user input corresponds with the chat room.

18. (canceled)

19. A non-transitory computer-readable recording medium storing instructions for causing performance of the method according to claim 1 on a computer.

20. A user terminal, comprising:
a communication module;
a memory storing one or more computer-readable programs;
a display; and
one or more processors operatively connected to the memory and configured to execute the one or more computer-readable programs included in the memory to:
receive, from a user, a first user input corresponding to a request for content indexing, and a content,
receive a second user input to cause an indexing of the received content, and
based on receiving the second input, generate a folder corresponding to the first user input or the second user input, and store the received content in the folder.

21. A method for indexing content in an instant messaging service, the method being performed by one or more processors of a user terminal and comprising:
receiving, from a user, a first input in a chat room of the instant messaging service corresponding to a request for content indexing;
after receiving the first input, receiving a content in the chat room of the instant messaging service;
after receiving the content, receiving a second user input to cause an indexing of the received content; and
based on receiving the second user input, generating a folder corresponding to the first user input or the second user input, and storing the received content in the folder.
